(19) United States
(12) Patent Application Publication
(10) Pub. No.: US 2004/0225399 A1
(43) Pub. Date: Nov. 11, 2004

(54) Wafer assessment apparatus for a single wafer machine and method thereof

(76) Inventors: Kuo-Lang Chen, Huatan Shiang (TW); Hsueh-Yao Ching, Hsinchu (TW)

Correspondence Address: BIRCH STEWART KOLASCH & BIRCH, PO BOX 747, FALLS CHURCH, VA, 22040-0747, US

(21) Appl. No.: 10/424,685

(22) Filed: Apr. 28, 2003

(51) Int. Cl. G06F 19/00

(52) U.S. Cl. 700/121; 700/305; 700/114

(57) ABSTRACT

A wafer assessment apparatus and method for a single wafer machine. The wafer assessment apparatus includes a pedestal, a movable supporting device, a weight measurement device, a signal transmission device and a control unit. The movable supporting device is disposed in the pedestal to support a wafer. The weight measurement device is disposed on the movable supporting device to measure the weight of the wafer. The signal transmission device is electrically connected to the weight measurement device to output a wafer weight signal. The control unit is electrically connected to the signal transmission device to receive and process the wafer weight signal to determine if the wafer is positioned correctly and/or damaged.

### BACKGROUND OF THE INVENTION

1. Field of the Invention

The invention relates to a wafer assessment apparatus and method for a single wafer machine, and more particularly to a wafer assessment apparatus and method that detect the weight change of a wafer before and after the wafer is processed, such that the conditions of the wafer and process can be identified.

2. Description of the Related Art

Generally speaking, semiconductor equipment can be divided into many categories, such as furnace, implantation, exposure, development, wet etching, dry etching, sputter, deposition and chemical mechanical apparatuses. The dry etching apparatus, sputter apparatus and deposition apparatus are single wafer machines.

When each reaction chamber of a single wafer machine is in operation, only one wafer is housed therein. As shown in FIG. 1, the single wafer machine includes two reaction chambers 11. Whenever a robot arm 12 transports a wafer from a cassette into a transfer chamber 13, a laser detector 14 disposed on the single wafer machine detects whether the wafer is clamped by the robot arm 12. In the transfer chamber 13, each laser detector 14 is disposed in front of each reaction chamber 11 and cassette chamber 15 to detect whether the wafer is in a predetermined position. As shown in FIG. 1, because the single wafer machine has two reaction chambers 11 and two cassette chambers 15, four laser detectors 14 are disposed on the transfer chamber 13.

Referring to FIG. 2, the laser detector 14 outputs laser 21. When the laser 21 encounters a wafer 22, reflected laser 23 is generated thereon and received by the laser detector 14, so that the single wafer machine can identify whether the wafer 22 is in the predetermined position.

Usually, the wafer assessment apparatus of the single wafer machine is in the transfer chamber 13. When the reaction chamber 11 is in operation, it is in a high-temperature and high-voltage condition and filled with chemical substances. Thus, the laser detector 14 cannot be disposed in the transfer chamber 13.

Referring to FIG. 3, because the reaction chamber 11 is in a high-temperature and high-voltage condition when in operation, the edge of the wafer 22 is easily attached to the pedestal 31 after the process is finished. When three lift pins 32 push the wafer 22 up, the wafer 22 becomes inclined. Then, when the robot arm 12 enters the reaction chamber 11 to clamp the wafer 22, the wafer 22 may be hit and damaged, thus causing contamination from micro particles in the reaction chamber 11. At this time, the single wafer machine is required to stop and undergo maintenance for a few days. In another aspect, the wafer 22 may be broken due to high inner stress when the deposition or sputter process is performed or after the deposition or sputter process is finished. Then, when the robot arm 12 transports the broken wafer into the cassette, the single wafer machine and other wafers in the cassettes are contaminated, thereby reducing reliability.

### SUMMARY OF THE INVENTION

An object of the invention is to provide a wafer assessment apparatus for semiconductor equipment. The wafer assessment apparatus comprises a pedestal, a movable supporting device, a weight measurement device, a signal transmission device and a control unit. The movable supporting device is disposed in the pedestal to support a wafer. The weight measurement device is disposed on the movable supporting device to measure the weight of the wafer. The signal transmission device is electrically connected to the weight measurement device to output a wafer weight signal. The control unit is electrically connected to the signal transmission device to receive and process the wafer weight signal to determine if the wafer is positioned correctly and/or damaged.

Accordingly, the movable supporting device further comprises a plurality of lift pins.

Accordingly, the plurality of lift pins are disposed in the pedestal or on the edge of the pedestal.

Accordingly, each lift pin further comprises a detection end connected to the weight measurement device. The wafer is placed on the detection end.

Accordingly, the weight measurement device is disposed in the upper or lower portion of each lift pin.

Accordingly, the weight measurement device further comprises a capacitance-voltage or piezoelectric transducer.

Another object of the invention is to provide a process detection apparatus for semiconductor equipment. The process detection apparatus comprises a pedestal, a movable supporting device, a weight measurement device, a signal transmission device and a control unit. The movable supporting device is disposed in the pedestal to support a wafer. The weight measurement device is disposed on the movable supporting device to detect the weight of the wafer. The signal transmission device is electrically connected to the weight measurement device to output a first wafer weight signal before a process and output a second wafer weight signal after the process. The control unit is electrically connected to the signal transmission device to receive and process the first and second wafer weight signals to determine the condition of the wafer in the process.

Accordingly, the movable supporting device further comprises a plurality of lift pins.

Accordingly, the plurality of lift pins are disposed in the pedestal or on the edge of the pedestal.

Accordingly, each lift pin further comprises a detection end connected to the weight measurement device. The wafer is placed on the detection end.

Accordingly, the weight measurement device is disposed in the upper or lower portion of each lift pin.

Accordingly, the weight measurement device further comprises a capacitance-voltage or piezoelectric transducer.

Another object of the invention is to provide a wafer assessment method for semiconductor equipment. The method comprises the steps of placing a wafer on a movable supporting device, measuring the weight of the wafer by means of a weight measurement device disposed on the movable supporting device, outputting a wafer weight signal by means of a signal transmission device electrically connected to the weight measurement device, processing the wafer weight signal by means of a control unit electrically connected to the signal transmission device, and determining whether the wafer is positioned correctly, or damaged.

Accordingly, the movable supporting device further comprises a plurality of lift pins.

Accordingly, each lift pin further comprises a detection end connected to the weight measurement device. The wafer is placed on the detection end.

Accordingly, the weight measurement device is disposed in the upper or lower portion of each lift pin.

Accordingly, the weight measurement device further comprises a capacitance-voltage or piezoelectric transducer.

Another object of the invention is to provide a process detection method for semiconductor equipment. The method comprises the steps of placing a wafer on a movable supporting device, measuring the weight of the wafer by means of a weight measurement device disposed on the movable supporting device, outputting a first wafer weight signal by means of a signal transmission device electrically connected to the weight measurement device, performing a predetermined process on the wafer, measuring the weight of the wafer by means of the weight measurement device, outputting a second wafer weight signal by means of the signal transmission device, processing the first and second wafer weight signals by means of a control unit electrically connected to the signal transmission device, and determining the condition of the wafer in the process.

Accordingly, the movable supporting device further comprises a plurality of lift pins.

Accordingly, each lift pin further comprises a detection end connected to the weight measurement device. The wafer is placed on the detection end.

Accordingly, the weight measurement device is disposed in the upper or lower portion of each lift pin.

Accordingly, the weight measurement device further comprises a capacitance-voltage or piezoelectric transducer.

### DESCRIPTION OF THE DRAWINGS

For a better understanding of the present invention, reference is made to a detailed description to be read in conjunction with the accompanying drawings, in which:

FIG. 1 is a schematic top view showing a single wafer machine;

FIG. 2 is a schematic view showing detection of a laser detector;

FIG. 3 is a schematic view showing operation of lift pins when the edge of a wafer is attached to a pedestal;

FIG. 4A is a schematic top view showing a reaction chamber;

FIG. 4B shows the lift pins and linking structure thereof;

FIG. 4C is a schematic view showing the wafer assessment apparatus of one embodiment of the invention;

FIG. 4D a schematic view showing the wafer assessment apparatus of the other embodiment of the invention; and

FIG. 5 is a schematic top view showing another reaction chamber.

### DETAILED DESCRIPTION OF THE INVENTION

The invention detects weight changes in a wafer in a reaction chamber of a single wafer machine before and after a process to identify whether the wafer is positioned or damaged.

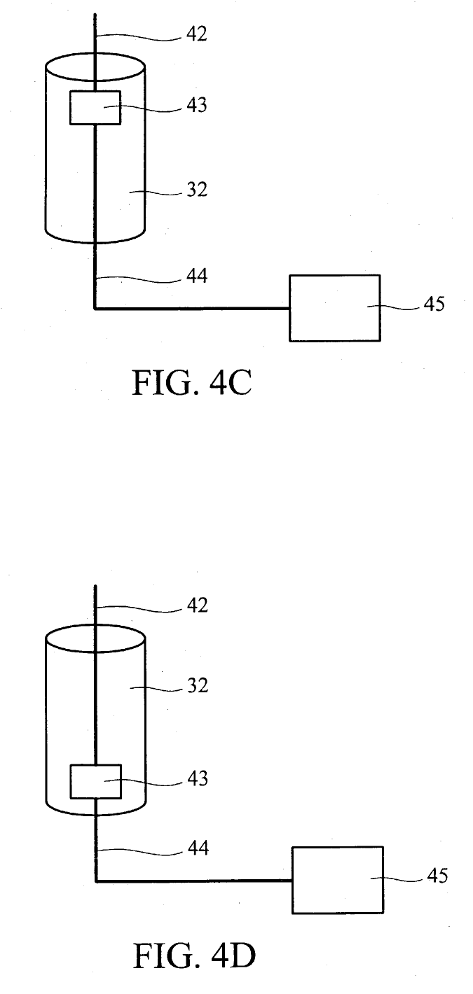

Referring to FIG. 4A, three lift pins 32 are disposed in a pedestal 31 of a reaction chamber 11.

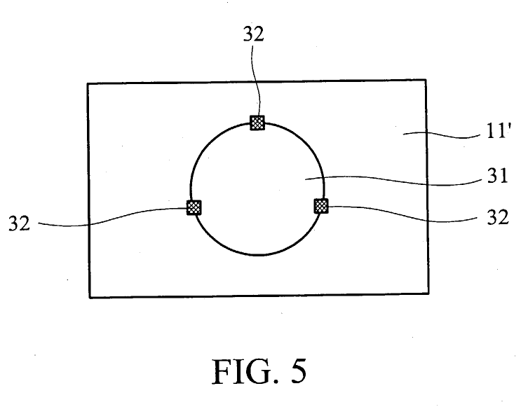

Referring to FIG. 5, three lift pins 32 are disposed on the edge of a pedestal 31 of another reaction chamber 11′.

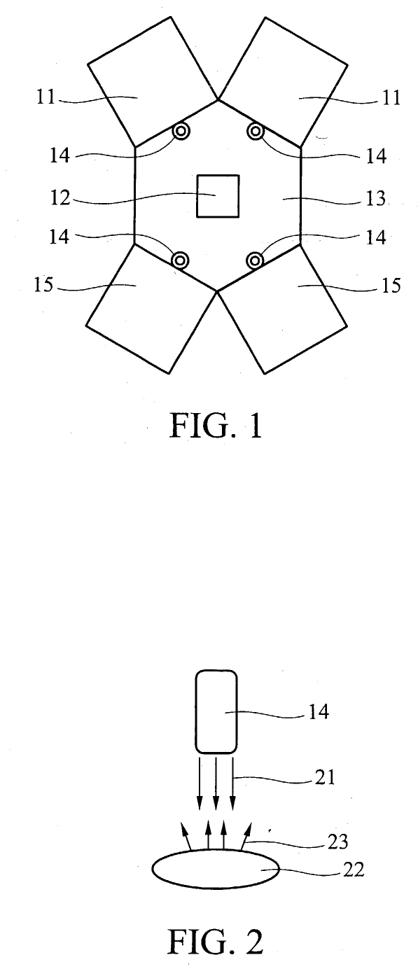

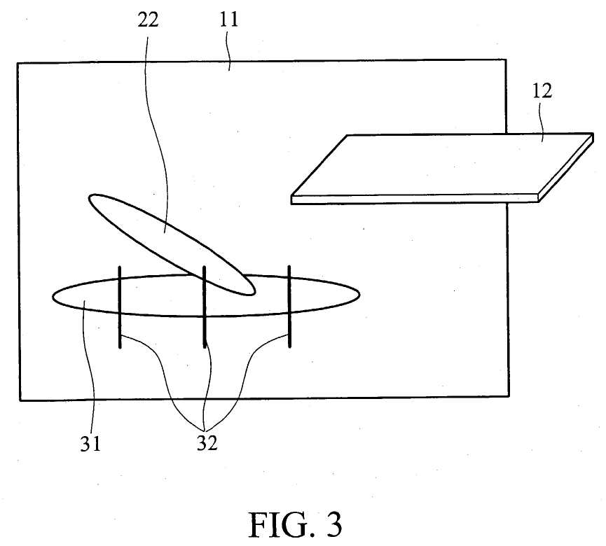

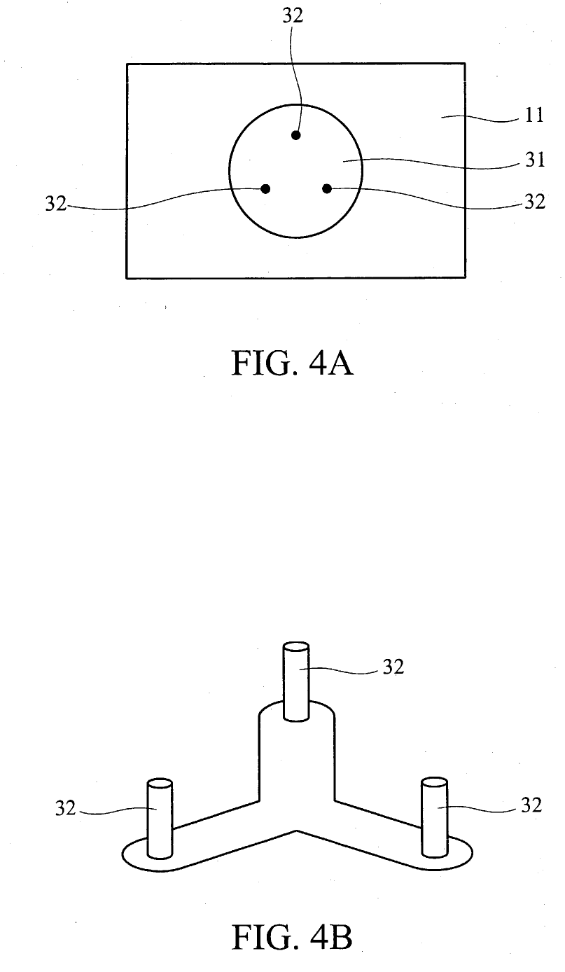

As shown in FIG. 1, FIG. 4A, FIG. 4B, FIG. 4C and FIG. 4D, when a cassette (not shown) loaded with a wafer is transported into the cassette chamber 15, the door of the cassette chamber 15 closes. Then, the cassette chamber 15 is evacuated by vacuum until the inner pressure thereof lowers to 10-5˜10-6 torr. At this time, the door between the transfer chamber 13 and the cassette chamber 15 opens and the robot arm 12 enters the cassette chamber 15 to clamp the wafer in the cassette. The robot arm 12 transports the wafer to the transfer chamber 13. Meanwhile, the laser detector 14 disposed in the transfer chamber 13 and near the cassette chamber 15 detects whether the wafer is transported to the transfer chamber 13 or not. After the wafer is transported to the transfer chamber 13, the robot arm 12 continues to transport the wafer to the reaction chamber 11. Meanwhile, the laser detector 14 disposed in the transfer chamber 13 and near the reaction chamber 11 detects whether the wafer is on the robot arm 12 or not. When the wafer is on the robot arm 12, the door of the reaction chamber 11 opens and the three lift pins 32 disposed in the pedestal 31 or on the edge of the pedestal 31 ascend. The top end of each lift pin 32 is higher than the pedestal 31. Then, the wafer is transported into the reaction chamber 11 by the robot arm 12 and placed on the three lift pins 32. The mass center of the wafer is required to be in the center of the three lift pins 32. When the wafer is placed on the three lift pins 32, a detection end 42 on each lift pin 32 is pushed down due to the weight of the wafer. At this time, the capacitance-voltage or piezoelectric transducer 43 connected to the detection end 42 converts the displacement of the detection end 42 to voltage or capacitance value. Specifically, the capacitance-voltage or piezoelectric transducer 43 can be disposed inside each lift pin 32. A signal transmission wire 44 connected to the capacitance-voltage or piezoelectric transducer 43 transmits the voltage or capacitance value to a control unit 45. The control unit 45 receives the voltage or capacitance values from the three lift pins 32 and calculates the weight borne by each lift pin 32 to acquire whether the mass center of the wafer is in the center of the three lift pins 32. Thus, the status of the wafer is assessed. If the wafer is not positioned or the wafer is damaged, the single wafer machine stops and sends out an alarm. Otherwise, the single wafer machine continues to perform the process.

When the three lift pins 32 descend until the top ends thereof are lower than the pedestal 31, the predetermined process commences. After the process is finished, the three lift pins 32 ascend to support the wafer again. Meanwhile, the detection end 42 on each lift pin 32 and capacitance-voltage or piezoelectric transducer 43 performs the aforementioned detection again and the voltage or capacitance values are transmitted to the control unit 45. The control unit 45 receives the voltage or capacitance values from the three lift pins 32 and calculates the weight borne by each lift pin 32 to determine whether the mass center of the wafer is still in the center of the three lift pins 32. Thus, the status of the wafer is assessed. If the wafer is not positioned or the wafer is damaged, the single wafer machine sends out an alarm and the robot arm 12 does not enter the reaction chamber 11 to clamp the wafer. Thus, the wafer is not damaged by the robot arm 12 or the damaged wafer is not transported to the cassette by the robot arm 12.

In another aspect, the control unit 45 can determine whether the wafer's weight has increased or decreased by a predetermined value according to information before and after the process. Thus, whether the process is normal or not can be identified. If the weight difference exceeds a predetermined tolerance range, the single wafer machine sends out an alarm to show that the etching or deposition process is abnormal. For example, such as when the weight of the wafer decreases after the etching process and the weight of the wafer increases after the sputter or deposition process.

To conclude, the invention can determine whether the wafer is positioned or damaged in the process. Also, the invention can determine whether the process is functioning normally. The wafer assessment apparatus of the invention can be disposed in the reaction chamber of the single wafer machine to detect the status of the wafer and process.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wafer assessment apparatus for semiconductor equipment, comprising:
a pedestal;
a movable supporting device disposed in the pedestal to support a wafer;
a weight measurement device disposed on the movable supporting device to measure the weight of the wafer;
a signal transmission device electrically connected to the weight measurement device to output a wafer weight signal; and
a control unit electrically connected to the signal transmission device to receive and process the wafer weight signal to determine if the wafer is positioned correctly or damaged.

2. The wafer assessment apparatus as claimed in claim 1, wherein the movable supporting device further comprises a plurality of lift pins.

3. The wafer assessment apparatus as claimed in claim 2, wherein the plurality of lift pins are disposed in the pedestal.

4. The wafer assessment apparatus as claimed in claim 2, wherein the plurality of lift pins are disposed on the edge of the pedestal.

5. The wafer assessment apparatus as claimed in claim 2, wherein each lift pin further comprises a detection end connected to the weight measurement device, with the wafer placed on the detection end.

6. The wafer assessment apparatus as claimed in claim 1, wherein the weight measurement device is selected from the group consisting of a capacitance-voltage transducer and a piezoelectric transducer.

7. The wafer assessment apparatus as claimed in claim 1, wherein the wafer assessment apparatus is used in a single wafer machine.

8. A process detection apparatus for semiconductor equipment, comprising:
a pedestal;
a movable supporting device disposed in the pedestal to support a wafer;
a weight measurement device disposed on the movable supporting device to measure the weight of the wafer;
a signal transmission device electrically connected to the weight measurement device to output a first wafer weight signal before a process and output a second wafer weight signal after the process; and
a control unit electrically connected to the signal transmission device to receive and process the first and second wafer weight signals to determine the status of the wafer in the process.

9. The process detection apparatus as claimed in claim 8, wherein the movable supporting device further comprises a plurality of lift pins.

10. The process detection apparatus as claimed in claim 9, wherein the plurality of lift pins are disposed in the pedestal.

11. The process detection apparatus as claimed in claim 9, wherein the plurality of lift pins are disposed on the edge of the pedestal.

12. The process detection apparatus as claimed in claim 9, wherein each lift pin further comprises a detection end connected to the weight measurement device, the wafer placed on the detection end.

13. The process detection apparatus as claimed in claim 8, wherein the weight measurement device is selected from the group consisting of a capacitance-voltage transducer and a piezoelectric transducer.

14. The process detection apparatus as claimed in claim 8, wherein the process detection apparatus is used in a single wafer machine.

15. A wafer detection method for semiconductor equipment, comprising the steps of:
placing a wafer on a movable supporting device;
measuring the weight of the wafer by means of a weight measurement device disposed on the movable supporting device;
outputting a wafer weight signal by means of a signal transmission device electrically connected to the weight measurement device;
processing the wafer weight signal by means of a control unit electrically connected to the signal transmission device; and
determining whether the wafer is positioned correctly, or damaged.

16. The wafer detection method as claimed in claim 15, wherein the movable supporting device further comprises a plurality of lift pins.

17. The wafer detection method as claimed in claim 16, wherein each lift pin further comprises a detection end connected to the weight measurement device, with the wafer placed on the detection end.

18. The wafer detection method as claimed in claim 15, wherein the weight measurement device is selected from the group consisting of a capacitance-voltage transducer and a piezoelectric transducer.

19. A process detection method for semiconductor equipment, comprising the steps of:
placing a wafer on a movable supporting device;
measuring the weight of the wafer by means of a weight measurement device disposed on the movable supporting device;
outputting a first wafer weight signal by means of a signal transmission device electrically connected to the weight measurement device;
performing a predetermined process on the wafer;
measuring the weight of the wafer by means of the weight measurement device;
outputting a second wafer weight signal by means of the signal transmission device;
processing the first and second wafer weight signals by means of a control unit electrically connected to the signal transmission device; and
determining the status of the wafer in the process.

20. The process detection method as claimed in claim 19, wherein the movable supporting device further comprises a plurality of lift pins.

21. The process detection method as claimed in claim 20, wherein each lift pin further comprises a detection end connected to the weight measurement device, the wafer placed on the detection end.

22. The process detection method as claimed in claim 19, wherein the weight measurement device is selected from the group consisting of a capacitance-voltage transducer and a piezoelectric transducer.
